(19) United States
(12) Patent Application Publication
(10) Pub. No.: US 2017/0187148 A1
(43) Pub. Date: Jun. 29, 2017

(54) INDEPENDENTLY POWERED USB CONNECTOR

(71) Applicant: Robert Andrew Priore, Waltham, MA (US)

(72) Inventor: Robert Andrew Priore, Waltham, MA (US)

(21) Appl. No.: 15/387,868

(22) Filed: Dec. 22, 2016

Related U.S. Application Data
(60) Provisional application No. 62/272,331, filed on Dec. 29, 2015.

(51) Int. Cl. H01R 13/658; H02M 7/04; H01R 24/28; H01R 13/66; H01R 24/60; H01R 43/20

(52) U.S. Cl. CPC H01R 13/658; H01R 24/60; H01R 43/20; H01R 24/28; H01R 13/6675; H02M 7/04

(57) ABSTRACT

An independently powered USB connector is provided. The independently powered USB connector replaces the computer USB power supply for the direct transmission of digital signals from and between computers and audio components, eliminating micro-circuitry and computer generated noise from the digital signal chain so as to prevent sonic coloration from these sources. The independent power supply is coupled to the male connection of the USB connector, wherein the coupling is wrapped with shrink wrap designed for stability.

### CROSS-REFERENCE TO RELATED APPLICATION

This application claims the benefit of priority of U.S. provisional application No. 62/272,331, filed 29 Dec. 2015, the contents of which are herein incorporated by reference.

### BACKGROUND OF THE INVENTION

The present invention relates to digital power supply systems and, more particularly, to an independently powered USB connector.

USB, short for Universal Serial Bus, is an industry standard that defines the cables, connectors and communications protocols used in a bus for connection, communication, and power supply between computers and electronic devices. USB connections are directed, with both upstream and downstream ports emanating from a single host. Thus, USB cables have different ends: A and B, with different physical connectors for each.

Computers generate Electromagnetic interference (EMI), also called radio-frequency interference (RFI), which affects the digital signal of high resolution music, making the music sound harsh, flat, and unpleasant.

Current devices solve this problem by forcing the digital signal of high resolution music through additional circuits, micro-circuitry, and in some cases full blown computers. This adds sound coloring EMI and RFI to the sensitive digital audio signal through these RFI and EMI generating systems.

As can be seen, there is a need for an independently powered USB connector, wherein the computer USB power supply is replaced with an independent source of clean power, for the direct transmission of digital signals from and between computers and audio components, eliminating micro-circuitry and computer generated noise from the digital signal chain so as to prevent sonic coloration from these sources.

### SUMMARY OF THE INVENTION

In one aspect of the present invention, a method of improving a USB connector having a female and male connection includes providing an independent power supply to the male connection of the USB connector.

In another aspect of the present invention, the method of improving a USB connector having a female and male connection includes providing an independent power supply to the male connection of the USB connector, wherein the independent power supply has a 5-volt output with no more than 2 Amps of output, and having a 10-Watt maximum; wherein a power lead from the independent power supply is connected to the male connection; connecting a first and second data line between the male and female connection of the USB connector; and coupling a ground of the power supply to a ground of the male and female connection; and wrapping shrink wrap around the power supply to male connection coupling for stability.

In yet another aspect of the present invention, an improved USB connection for removing sonic coloration of digital music during direct transmission from and between computers and audio components includes a USB connector having a female and an opposing male connection; and an independent power supply coupled to the male connection of the USB connector, wherein a power lead from the independent power supply is connected to the male connection; a first and second data line connected between the male and female connection of the USB connector; and a ground of the power supply coupled to a ground of the female connection and to a ground of the male connection.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is a rear perspective view of an exemplary embodiment of the present invention; and

FIG. 3 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an independently powered USB connector. The independently powered USB connector replaces the computer USB power supply for the direct transmission of digital signals from and between computers and audio components, eliminating micro-circuitry and computer generated noise from the digital signal chain so as to prevent sonic coloration from these sources. The independent power supply is coupled to the male connection of the USB connector, wherein the coupling is wrapped with shrink wrap for stability.

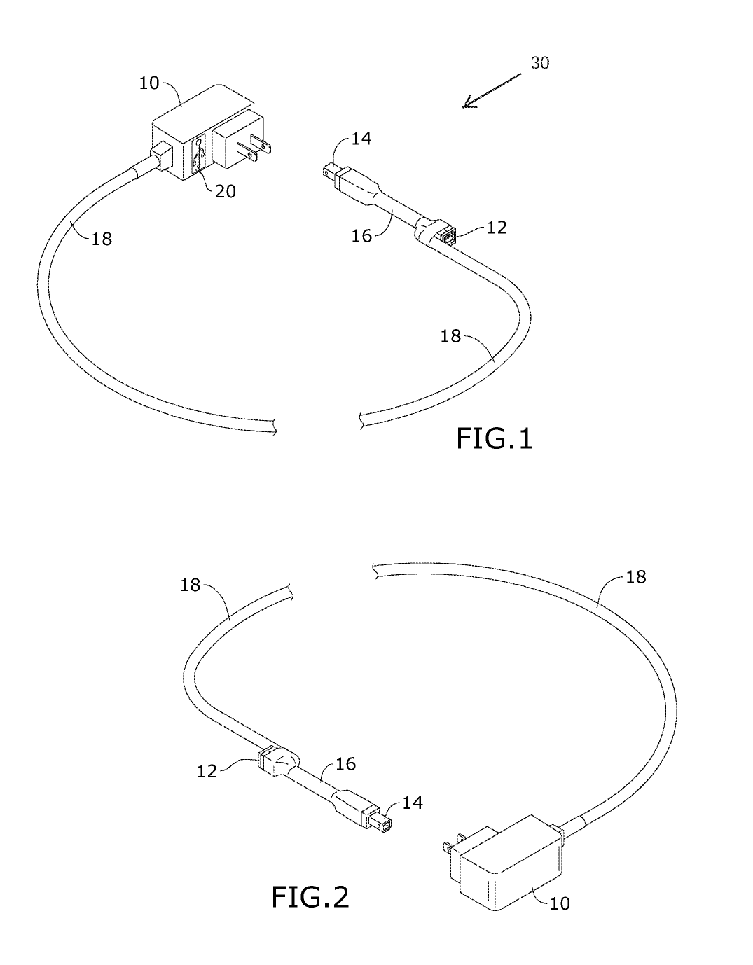

Referring to FIGS. 1 through 3, the present invention may include an improved, independently powered USB connector 30. The independently powered USB connector 30 may include a power supply 10 coupled to a USB female connector 12 and a male USB connector 14 by way of a cable 18, wherein the USB female connector 12 and the male USB connector 14 coupling with the power supply 10 may include heat shrink wrap 16. The power supply 10 may include a low-noise, 5 volt 500 ma to 2 Amps power supply. In certain embodiments the power supply 10 has a 5-volt output with no more than 2 Amps of output and having a 10-Watt maximum, but always 5 volts. The power supply 10 should not have or induce noise that affects audio components.

The USB female and male connectors 12 and 14 may include any of various types, such as surface mount, single end, Type B, Type A, Micro, or Mini USB connectors. The heat shrink wrap 16 may be any of various sizes and lengths. The cable 18 may be any electrically conductive material with a protective covering.

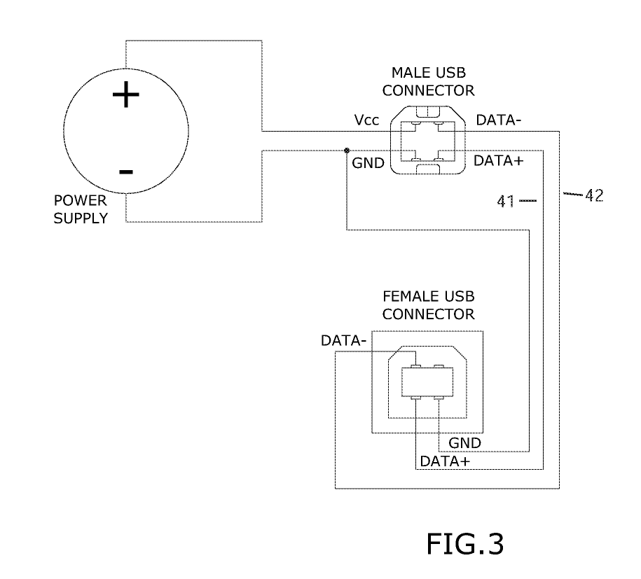

A method of improving a standard USB cable may include the following. An individual may remove the power leads on the standard USB female connector 12 so as to connect the ground of the power supply 10 to the ground of the female USB connector 12, and connect the ground of the power supply 10 to the ground of the male USB connector 14, as illustrated in FIG. 3. The individual may then connect the power supply 10 to the male USB connector 14, and then connect the first and second data lines 41 and 42 between USB male connector 14 and USB female connector 12, as illustrated in FIG. 3. The shrink wrap 16 may be wrapped to couple the power supply (cable 18) to the USB female and male connectors 12 and 14 so as to provide stability and safety.

A method of using the present invention to stop noise polluting EMI and/or RFI from coloring the sound of high resolution digital audio served from a computer include providing the improved, independently powered USB connector 30 disclosed above. The independently powered USB connector 30 has a power lead from the power supply 10 coupling to the male USB connector 14, and the ground wire from the power supply 10 coupling to the male USB and female USB connector 14 and 12, then data lines are connected between the male and female USB. In certain embodiments, the male and female data lines are connected using two three-inch wires.

A user may plug the power supply 10 of the independently powered USB connector 30 into a standard or European receptacle, working on multiple voltages. Then the user may couple the independently powered USB connector 30 between digital music audio components, such a USB DAC (digital to analog converter) and a computer. Wherein certain embodiments a standard USB cable interconnects one component (such as the computer) and the independently powered USB connector 30 (in certain embodiments via the female USB connector 12 of the independently powered USB connector 30) that connects to the audio component.

Thereby, the independently powered USB connector 30 eliminates the micro-circuitry of the computer as it does not draw the voltage load, leaving it idle. And thus eliminating the noise that would affect the digital sound of the high resolution audio. The present invention is also multi-directional, from the computer to audio component and vice versa.

The independently powered USB connector can be used in any scenario that requires USB power without computer noise. For example, in recording studios with USB powered microphones, and in sensitive medical testing equipment. Also in multiple electrical testing scenarios that involve computers and USB cables connected to measurement devices. Additionally, the independently powered USB connector 30 can be used in any application that requires clean USB power from a computer.

It should be understood, of course, that the foregoing relates to exemplary embodiments of the invention and that modifications may be made without departing from the spirit and scope of the invention as set forth in the following claims.

What is claimed is:

1. A method of improving a USB connector having a female and male connection, comprising:
providing an independent power supply to the male connection of the USB connector.

2. The method of claim 1, wherein the independent power supply has a 5-volt output with no more than 2 Amps of output, and having a 10-Watt maximum.

3. The method of claim 1, wherein a power lead from the independent power supply is connected to the male connection.

4. The method of claim 1, coupling a ground of the power supply to a ground of the female connection and to a ground of the male connection.

5. The method of claim 1, connecting a first and second data line between the male and female connection of the USB connector.

6. The method of claim 4, wrapping shrink wrap at least about the power supply to female connection coupling.

7. A method of improving a USB connector having a female and male connection, comprising:
providing an independent power supply to the male connection of the USB connector, wherein the independent power supply has a 5-volt output with no more than 2 Amps of output, and having a 10-Watt maximum, and wherein a power lead from the independent power supply is connected to the male connection;
connecting a first and second data line between the male and female connection of the USB connector; and
coupling a ground of the power supply to a ground of the female connection and to a ground of the male connection.

8. An improved USB connection for removing sonic coloration of digital music during direct transmission between computers and audio components, comprising:
a USB connector having a female and an opposing male connection; and
an independent power supply coupled to the male connection of the USB connector, wherein a power lead from the independent power supply is connected to the male connection;
a first and second data line connected between the male and female connection of the USB connector; and
a ground of the power supply coupled to a ground of the female connection and to a ground of the male connection.

9. The improved USB connection of claim 8, wherein the independent power supply has a 5-volt output with no more than 2 Amps of output.

10. The improved USB connection of claim 8, further comprising a shrink wrap wrapped at least about the power supply to female connection coupling for stability.
